(19) United States
(12) Patent Application Publication
(10) Pub. No.: US 2024/0369991 A1
(43) Pub. Date: Nov. 7, 2024

(54) INTELLIGENT CONTROL SYSTEM AND INTELLIGENT CONTROL METHOD THEREOF

(71) Applicant: Chih-Feng TSAI, New Taipei City (TW)

(72) Inventor: Chih-Feng TSAI, New Taipei City (TW)

(21) Appl. No.: 18/652,064

(22) Filed: May 1, 2024

(30) Foreign Application Priority Data
May 4, 2023 (TW) 112116627

(51) Int. Cl. G05B 19/4155; H04B 3/54

(52) U.S. Cl. CPC G05B 19/4155; H04B 3/54; G05B 2219/34465

(57) ABSTRACT

An intelligent control system and an intelligent control method thereof are disclosed. The intelligent control system is capable of controlling from a control terminal an electrical equipment located at an equipment terminal. The intelligent control system comprises a master control device and a slave control device. The master control device is located at the control terminal and has a first micro-control unit to receive a control command from an external control system. The slave control device is located at the equipment terminal and has a second micro-control unit. The first micro-control unit and the second micro-control unit are used for transmitting a communication signal bidirectionally via a power line. Thus, the slave control device can receive the control command from the master control device, and the master control device can receive a status signal from the slave control device.

### BACKGROUND OF THE INVENTION

### 1. Field of the Invention

The present invention relates to an intelligent control system and an intelligent control method thereof, and specifically to an intelligent control system and an intelligent control method thereof capable of utilizing power line communication technology for control.

### 2. Description of the Related Art

In today's industrial automation control equipment, electrical equipment outside the distribution panel is typically controlled by installing related motor control components at the distribution panel. However, in the prior art, the external control system usually does not control only a single electrical equipment. To control a plurality of electrical equipment, a large-sized control panel is needed. Moreover, a control panel typically accommodates only around 10 to 20 sets of electrical equipment, whereas in medium- to large-scale factories nowadays, hundreds of sets of electrical equipment are often required. Consequently, more factory space needs to be allocated for multiple external control systems. In the valuable real estate of the factory environment, improving space utilization is a crucial issue. Additionally, with the advent of Industry 4.0, each manufacturer needs to install independent monitoring devices and additional wiring for monitoring power equipment, which incurs considerable costs for each manufacturer.

Therefore, it is necessary to invent a new intelligent control system and an intelligent control method thereof to address the shortcomings of the prior art.

### SUMMARY OF THE INVENTION

It is a primary objective of the present invention to provide an intelligent control system capable of utilizing power line communication technology for control purposes.

Another primary objective of the present invention is to provide an intelligent control method for the aforementioned system.

To achieve the above objectives, the intelligent control system of the present invention is capable of controlling from the control terminal electrical equipment located at the equipment terminal. The intelligent control system comprises a main control device and a slave control device. The main control device is located at the control terminal and is configured to receive a control command from an external control system. The main control device includes a first micro-control unit. The slave control device is located at the equipment terminal and includes a second micro-control unit. The slave control device is electrically connected to the electrical equipment and is connected to the main control device via a power line, enabling bidirectional transmission of communication signals between the first micro-control unit and the second micro-control unit through the power line. Consequently, the slave control device can receive control commands from the main control device, while the main control device can receive a status signal from the slave control device.

The intelligent control method of the present invention includes the following steps: causing the main control device to receive a control command from the external control system; transmitting the control command via the power line to the slave control device; causing the slave control device to control the electrical equipment; and enabling the main control device to receive a status signal from the slave control device via the power line.

### BRIEF DESCRIPTION OF THE DRAWINGS

All of the objects and advantages of the present invention will become apparent from the following descriptions of the accompanying drawings, which disclose several embodiments of the present invention. It is to be understood that the drawings are to be used for purposes of illustration only, and not as a definition of the invention.

FIG. 1 illustrates a schematic diagram of the architecture of the intelligent control system of the present invention.

FIG. 2 illustrates a flowchart of the steps of the first embodiment of the intelligent control method of the present invention.

FIG. 3 illustrates a flowchart of the steps of the second embodiment of the intelligent control method of the present invention.

### DETAILED DESCRIPTION OF THE PREFERRED EMBODIMENTS

Hereafter, the technical content of the present invention will be better understood with reference to preferred embodiments.

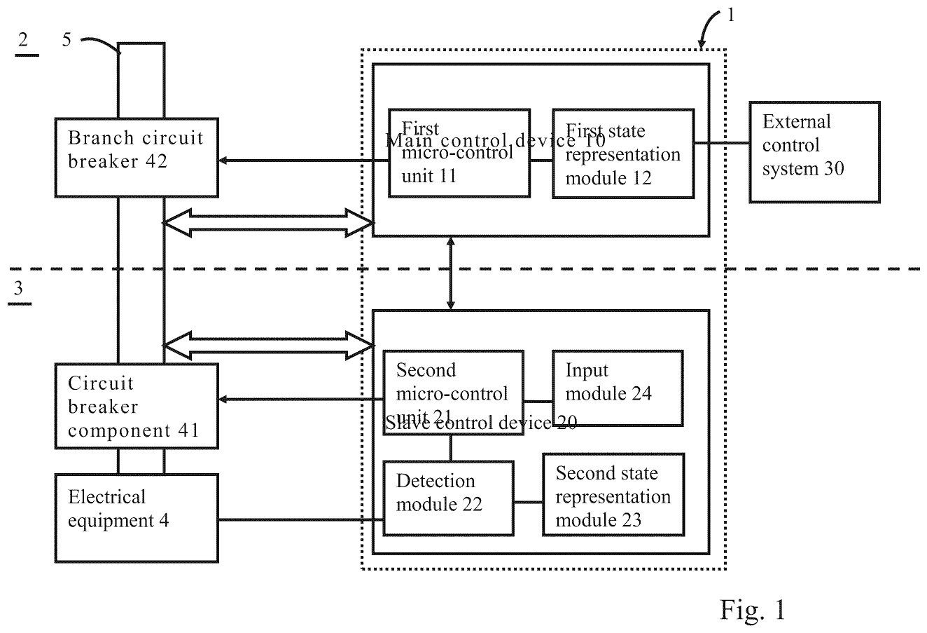

Please refer to FIG. 1, which illustrates a schematic diagram of the architecture of the intelligent control system of the present invention.

In one embodiment of the present invention, the intelligent control system 1 comprises a main control device 10 and a slave control device 20. The main control device 10 is located at a control terminal 2, while the slave control device 20 is located at an equipment terminal 3, and both are electrically connected via a power line 5. The control terminal 2 can be a distribution panel, and the equipment terminal 3 has electrical equipment 4, which can be an electric motor, pump, fan, compressor, etc., although the present invention is not limited to these. The main control device 10, the slave control device 20, and the electrical equipment 4 all use the power line 5 to receive power signals, and the main control device 10 and the slave control device 20 also utilize a power line communication technology of the power line 5 to bidirectionally transmit a communication signal. In case of a malfunction in the power line communication technology of the power line 5, the main control device 10 and the slave control device 20 can use spare communication modules to transmit signals, such as modules suitable for communication transport protocols such as RS-485 or Ethernet, although the present invention is not limited to these. It should be noted that the present invention may also include a plurality of slave control devices 20, each electrically connected to a plurality of electrical equipment 4. The present invention does not limit the number of electrical equipment 4, allowing the main control device 10 to simultaneously control the plurality of slave control devices 20.

In one embodiment of the present invention, the main control device 10 comprises a first micro-control unit 11 and a first state representation module 12, while the slave control device 20 comprises a second micro-control unit 21, a detection module 22, a second state representation module 23, and an input module 24. Each module is electrically interconnected. The main control device 10 primarily receives the control command from an external control system 30, which is a system operated directly by an operator and can be connected to the main control device 10 by wired or wireless means. Upon receiving the control command, the main control device 10 controls the slave control device 20 through the power line 5. For example, when the second micro-control unit 21 of the slave control device 20 receives an operation command from the first micro-control unit 11 of the main control device 10, it outputs a signal to start the electrical equipment 4, thereby controlling high-power control components such as electromagnetic contactors, solid-state relays, or inverters of the electrical equipment 4. Alternatively, operators can directly operate the input module 24 at the equipment terminal 3 such that the slave control device 20 receives commands to control the electrical equipment 4. The input module 24 can be a physical button or a touch screen interface, among others. Thus, the second micro-control unit 21 of the slave control device 20 can receive the control command from the first micro-control unit 11 of the main control device 10, which is ultimately used to control the electrical equipment 4.

Furthermore, the first micro-control unit 11 of the main control device 10 can receive a status signal from the second micro-control unit 21 of the slave control device 20 via the power line 5. In one embodiment of the present invention, the detection module 22 of the slave control device 20 is used to detect the status of the electrical equipment 4 and generate the status signal. The status of the electrical equipment 4 can include voltage values, current values, temperature values, or vibration amplitudes, among others, but the present invention is not limited thereto. The second state representation module 23 of the slave control device 20 can display the aforementioned status signal. Thus, the second micro-control unit 21 determines whether the electrical equipment 4 is abnormal based on the voltage, current, temperature, or vibration status signal. Examples of abnormalities include abnormal voltage, excessively high or low current, high temperature, or excessive vibration amplitude. If an abnormality is detected, the second micro-control unit 21 controls the circuit breaker component 41 at the equipment terminal 3 to cut off power to the electrical equipment 4.

On the other hand, the first micro-control unit 11 receives and records the status signal via the power line 5 and displays it on the first state representation module 12 of the main control device 10. The status signal can be used for future data analysis by operators, and the present invention does not limit the use of the status signal. Both the first state representation module 12 and the second state representation module 23 mentioned above can utilize indicators or display screens for representation. When the second micro-control unit 21 controls the circuit breaker component 41 at the equipment terminal 3 to cut off power to the electrical equipment 4, it transmits this abnormal status signal via the power line 5 to the main control device 10. This allows the first micro-control unit 11 to control the branch circuit breaker 42 in the distribution panel to isolate the power source, thereby ensuring personnel and equipment safety.

It should be noted that the intelligent control system 1 can be structured as hardware devices, software programs combined with hardware devices, firmware combined with hardware devices, and other configurations. However, the present invention is not limited to the above-mentioned configurations. Additionally, this embodiment only illustrates a preferred embodiment of the present invention and is not intended to be limited to such embodiments. To avoid redundancy, not all possible combinations of variations have been described in detail. However, those skilled in the art should understand that the various modules or components mentioned above may not all be necessary. Furthermore, to implement the present invention, it may also include other known modules or components in more detail. Each module or component may be omitted or modified as needed, and there may be other modules or components between any two modules. Anything within the basic framework of the present invention should be within the scope claimed by the patent, and the scope of the patent application shall prevail.

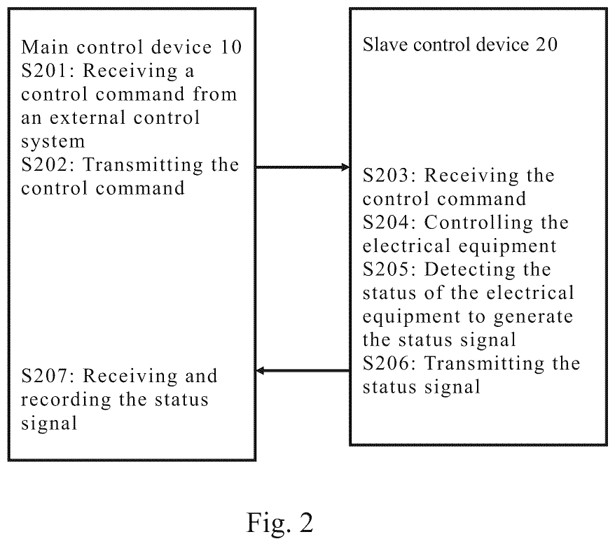

Please refer to FIG. 2, which illustrates a flowchart of the steps in the first embodiment of the intelligent control method of the present invention. It is important to note that although the following description uses the intelligent control system 1 as an example to illustrate the intelligent control method of the present invention, the method is not limited to use with the same structure as the intelligent control system 1 described above.

In the first embodiment of the present invention, the main control device 10 initiates step S201: receiving a control command from an external control system.

First, the first micro-control unit 11 of the main control device 10 receives the control command obtained by the operator operating the external control system 30.

Next, the method proceeds to step S202: transmitting the control command.

Then, after receiving the control command, the first micro-control unit 11 of the main control device 10 transmits the control command to the second micro-control unit 21 of the slave control device 20 via the power line 5.

Therefore, at this point, the slave control device 20 executes step S203: receiving the control command.

At this moment, the second micro-control unit 21 of the slave control device 20 receives the control command and proceeds with step S204: controlling the electrical equipment.

The second micro-control unit 21 of the slave control device 20 will control the electrical equipment 4 based on the control command. For example, when the second micro-control unit 21 receives the operation command from the first micro-control unit 11 of the main control device 10, it will output a signal to start the electrical equipment 4. Additionally, the slave control device 20 also allows operators to directly control the electrical equipment 4 at the equipment terminal 3.

Next, the method proceeds to step S205: detecting the status of the electrical equipment to generate the status signal.

At this point, the detection module 22 of the slave control device 20 will detect the status of the electrical equipment 4 to generate the status signal. The status of the electrical equipment 4 may include a voltage value, a current value, a temperature value, or a vibration amplitude. Additionally, the second state representation module 23 of the slave control device 20 can display the aforementioned status signal.

Next, the method proceeds to step S206: transmitting the status signal.

The slave control device 20 will transmit the status signal to the main control device 10 via the power line 5.

Next, the main control device 10 proceeds to step S207: receiving and recording the status signal.

The first micro-control unit 11 receives and records the status signal via the power line 5, allowing the status signal to be available for future data analysis by operators. Furthermore, it is displayed on the first state representation module 12 of the main control device 10.

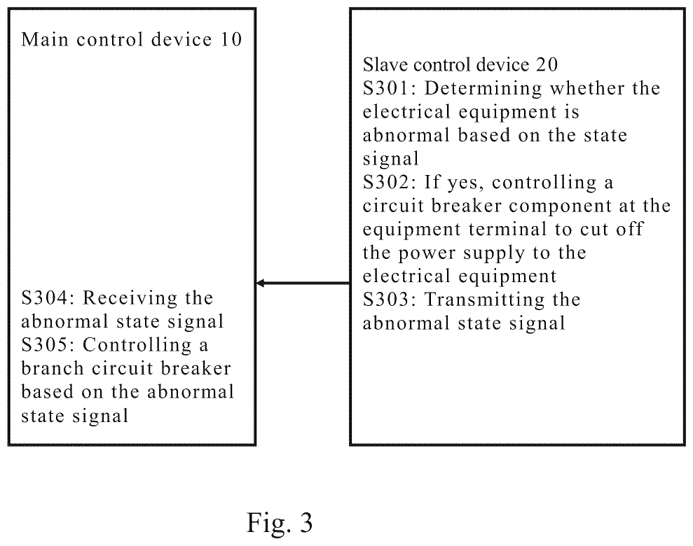

Next, please refer to FIG. 3, which illustrates a flowchart of the steps of a second embodiment of the intelligent control method of the present invention.

In the second embodiment of the present invention, the slave control device 20 first performs step S301: determining whether the electrical equipment is abnormal based on the state signal.

The second micro-control unit 21 of the slave control device 20 determines whether the electrical equipment 4 is abnormal based on the state signal, which includes voltage value, current value, temperature value, or vibration magnitude. Examples of abnormalities include abnormal voltage, excessively high or low current, high temperature, or excessive vibration magnitude.

Next, the method proceeds to step S302: if yes, controlling a circuit breaker component at the equipment terminal to cut off the power supply to the electrical equipment.

In case of any abnormality, the second micro-control unit 21 controls the circuit breaker component 41 at the equipment terminal 3 to cut off the power supply to the electrical equipment 4.

Simultaneously, step S303 is carried out: transmitting the abnormal state signal.

Simultaneously, the second micro-control unit 21 transmits this abnormal state signal to the main control device 10 via the power line 5.

Therefore, the main control device 10 will proceed to step S304: receiving the abnormal state signal, and then to step S305: controlling a branch circuit breaker based on the abnormal state signal.

The first micro-control unit 11 determines the presence of an abnormal condition based on the received abnormal state signal. Subsequently, it controls the branch circuit breaker 42 installed in the distribution panel to isolate the power source, thereby ensuring the safety of personnel and equipment.

It is important to note that the intelligent control method of the present invention is not limited to the sequence of steps described above. As long as the purpose of the present invention is achieved, the sequence of steps described above can be altered accordingly.

By employing the aforementioned intelligent control system 1 and the intelligent control method thereof, certain functionalities can be delegated to the slave control device 20 located at the equipment terminal 3. This allows for a reduction in the space required for the main control device 10 at the control terminal 2. Additionally, operators can monitor the status of electrical equipment 4 without needing to physically access the equipment terminal 3. This effectively addresses the shortcomings of the prior art.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An intelligent control system, capable of controlling from a control terminal an electrical equipment located at an equipment terminal; the control terminal comprising an external control system; the intelligent control system comprising:
a main control device, located at the control terminal, configured to receive a control command from an external control system, the main control device having a first micro-control unit;
a slave control device located at the equipment terminal, comprising a second micro-control unit and electrically connected to the electrical equipment and connected to the main control device via a power line, so as to transmit a bidirectional communication signal between the first micro-control unit and the second micro-control unit via the power line; thus, the slave control device can receive the control command from the main control device, and the main control device can receive a status signal from the slave control device;
a circuit breaker component located at the equipment terminal to electrically connect the electrical equipment, wherein the second micro-control unit determines whether the electrical equipment is abnormal based on the state signal so as to control the circuit breaker component based on an abnormal state signal to disconnect power to the electrical equipment; and
a branch circuit breaker located at the control terminal, wherein when the circuit breaker component disconnects power to the electrical equipment, the second micro-control unit transmits the abnormal state signal via the power line to the main control device, enabling the first micro-control unit to control the branch circuit breaker based on the abnormal state signal to isolate power.

2. The intelligent control system as claimed in claim 1, wherein the slave control device further comprises a detection module for detecting a state of the electrical equipment so as to generate the state signal, wherein the state of the electrical equipment includes a voltage value, a current value, a temperature value, or a vibration amplitude of the electrical equipment.

3. The intelligent control system as claimed in claim 1, wherein the first micro-control unit receives and records the state signal via the power line.

4. The intelligent control system as claimed in claim 3, wherein the main control device further comprises a first state representation module, and the slave control device further comprises a second state representation module; the first state representation module and the second state representation module are used to display the state signal.

5. The intelligent control system as claimed in claim 1, wherein the slave control device further comprises an input module, configured to receive a command at the equipment terminal to control the electrical equipment.

6. The intelligent control system as claimed in claim 1, further comprising a plurality of slave control devices, each electrically connected to a plurality of electrical equipment respectively.

7. An intelligent control method, used in an intelligent control system, wherein the intelligent control system comprises a main control device located at a control terminal and a slave control device located at an equipment terminal, for controlling an electrical equipment; the intelligent control method comprising the following steps:
receiving, by a first micro-control unit of the main control device, a control command from an external control system;
transmitting the control command to the slave control device via a power line;
controlling the electrical equipment by the slave control device;
allowing the main control device to receive a status signal from the slave control device via the power line;
utilizing a second micro-control unit of the slave control device to determine whether the electrical equipment is abnormal based on the status signal so as to control a circuit breaker component of the equipment terminal based on an abnormal state signal to disconnect power to the electrical equipment; and
utilizing the second micro-control unit to transmit the abnormal status signal via the power line to the main control device, thus allowing the first micro-control unit to control a branch circuit breaker based on the abnormal status signal to isolate power.

8. The intelligent control method as claimed in claim 7, further comprising the following steps:
detecting a status of the electrical equipment by the slave control device to generate the status signal, wherein the status of the electrical equipment includes a voltage value, a current value, a temperature value, or a vibration amplitude of the electrical equipment.

9. The intelligent control method as claimed in claim 8, further comprising the following step:
causing the main control device and the slave control device to display the status signal.

10. The intelligent control method as claimed in claim 7, further comprising the following step:
causing the slave control device to receive commands at the equipment terminal to control the electrical equipment.
